(19) United States
(12) Patent Application Publication
(10) Pub. No.: US 2009/0069926 A1
(43) Pub. Date: Mar. 12, 2009

(54) CNC apparatus with mechanism for controlling length variation of lead screw due to thermal expansion and method therefor

(75) Inventor: Tsu-Wen Ma, Hsinpu Town (TW)

Correspondence Address: BIRCH STEWART KOLASCH & BIRCH, PO BOX 747, FALLS CHURCH, VA, 22040-0747, US

(73) Assignee: Awea Mechantronic Co., Ltd.

(21) Appl. No.: 11/898,319

(22) Filed: Sep. 11, 2007

(51) Int. Cl. G05B 19/18

(52) U.S. Cl. 700/160

(57) ABSTRACT

CNC apparatus having a mechanism for controlling length variation of a lead screw due to thermal expansion and method therefore when the apparatus is rotating in high speed and/or when load is high are disclosed. The lead screw is supported by two spaced ball bearing sets and is hollow to permit cooling fluid to flow through. A deflection detecting unit is disposed proximate one ball bearing set for detecting its deflection. In one embodiment, an adjusting nut is operatively connected to one end of the lead screw and is adapted to pre-stress the ball bearing set. The method includes pre-stressing the ball bearing set for deflecting in one direction and in operation in response to detecting the ball bearing set deflected in an opposite direction cooling the lead screw for substantially maintaining its length unchanged with respect to a bed.

### BACKGROUND OF THE INVENTION

1. Field of Invention

The invention relates to devices for controlling length variation of a mechanical element and more particularly to a computer numerical control (CNC) machine for controlling length variations of the lead screw due to thermal expansion in high speed rotation and/or high load, thereby maintaining the length of the lead screw unchanged with respect to a bed. Moreover, the invention relates to a method for controlling such length variations in which pre-stressing, deflection detection and cooling are involved.

2. Description of Related Art

Length variation (e.g., elongation) due to thermal expansion is a potential problem for any mechanical device in operation. Thus, how to effectively control length variation of a device in operation is an important issue.

Referring to FIG. 1, in a first typical arrangement a feed mechanism 12 is fixedly secured to a threaded carrier 11 which is again threadedly put on a lead screw 10. The lead screw 10 has one end being supported by a first ball bearing 13 and secured by a nut 14, and the other end being supported by a second ball bearing set 15 and secured by a nut 16. Distance between the two nuts 14 and 16 cannot be changed since both the first and second ball bearing sets 13, 15 are fixed. That is, no axial movement (i.e., length increase or decrease) of the lead screw 10 and no radial movement thereof are allowed. Hence, the first ball bearing set 13 and/or the second ball bearing set 15 may be damaged because the lead screw 10 may increase its length due to thermal expansion when the feed mechanism 12 is rotating in high speed and/or when load is high.

Referring to FIG. 2, in a second typical arrangement as an improvement of the first typical arrangement cooling fluid, as indicated by arrows, feeds through the hollow lead screw 10 for cooling. However, in practice it is found that temperature distribution along the lead screw can not be maintained evenly because some parts of the lead screw may receive more thermal load than others. Further, only one thermometer is placed in a predetermined point of the cooling path (i.e., only one control point). This is, however, not sufficient. Only the control point can be maintained close to the pre-determined reference temperature. As such, obtained temperature data of the arrangement is not correct, resulting in an insufficient cooling of the arrangement. The undesired insufficient cooling is particularly significant for an elongated lead screw 10. Hence, the problem of length variation due to thermal expansion has not been solved.

Referring to FIG. 3, in a third typical arrangement a feed mechanism 22 is fixedly secured to a threaded carrier 21 which is again threadedly put on a lead screw 20. The lead screw 20 has one end being supported by a first ball bearing 23 set and secured by a nut 24, and the other end being supported by a second ball bearing 25 set and secured by a nut 26. The rows 251, 252 of balls of the second ball bearing 25 are positioned by rings disposed in the same direction (i.e., the second ball bearing 25 is adapted to deflect relative to a underlying bed (not numbered)) and the rows of balls of the first ball bearing 23 are positioned by rings disposed in opposing directions (i.e., the first ball bearing 23 is not adapted to deflect). Thus, the lead screw 20 is not allowed to extend leftward. Further, the lead screw 20 is only allowed to extend toward right (i.e., rightward axial movement) due to thermal expansion when the machine is rotating in high speed and/or when load is high. As such, both the ball bearings 23 and 25 are (i.e., the feed mechanism is) prevented from being damaged. However, positioning accuracy of the feed mechanism 22 degrades significantly. Moreover, axial stiffness of the feed mechanism 22 is lowered undesirably, as compared to first and second typical arrangements, in the rotating operation.

Referring to FIG. 4, in a fourth typical arrangement as an improvement of the third typical arrangement a deflection detection unit 27 is provided proximate the second ball bearing 25 at the other end of the lead screw 20. The deflection detection unit 27 is adapted to detect movement of the lead screw 20 (i.e., elongation) due to thermal expansion and sends the displacement data to a control unit 28. The control unit 28 obtains data of the length variation of the lead screw 20 and the current position of the feed mechanism 22 from a rotary encoder 29 attached to a motor 30, and then performs extensive calculation based on the data received. The calculation is summarized as following:

$$Compensation = \frac{\begin{matrix}Length\_Variation \_Dectected \cdot \\ Current\_Position \_of \_Feed \_Mechanism\end{matrix}}{Total\_Length \_of \_Lead \_Ccrew}$$

The compensation value is then feedback to the motor 30 as command. The motor 30 drives the lead screw 20 to counteract the effect of thermal expansion on the positioning of feed mechanism 22. As a result, precision (i.e., positioning accuracy) is improved greatly. However, there are still some very small positioning errors due to uneven temperature distribution of the lead screw 20. The compensation calculation assumes heat is evenly distributed on the lead screw 20, i.e., temperature is constant along the lead screw 20. Furthermore, the fourth typical arrangement does not solve the problem of lower axial stiffness of the feed mechanism 22. The axial stiffness of the feed mechanism 22 decreases as it travels away from the motor 30.

Referring to FIG. 5, in a fifth typical arrangement, as another improvement of the third typical arrangement, a linear scale 28 is mounted parallel to the axial direction of the lead screw 20. The linear scale 28 is adapted to precisely feedback the current position of the feed mechanism 22 to the controller. Thus, the length variation of the lead screw 20 due to thermal expansion, when the machine is rotating in high speed and/or when load is high, does not affect the positioning accuracy of the feed mechanism 22. However, the cost of the linear scale 28 is relatively high as compared to that of a rotary encoder. Furthermore, the fifth typical arrangement does not solve the problem of lower axial stiffness of the feed mechanism 22. The axial stiffness of the feed mechanism 22 decreases as it travels away from a motor (not numbered). Thus, a need for improvement exists.

### SUMMARY OF THE INVENTION

It is therefore one object of the invention to provide a CNC apparatus with a mechanism for controlling length variations of the lead screw due to thermal expansion in high speed rotation and/or high load so as to maintain the length of the lead screw substantially unchanged with respect to a bed, have a desired positioning accuracy, have a strong axial stiffness similar to that of the first typical arrangement mentioned in prior art, and prevent the apparatus from being damaged.

It is another object of the invention to provide a method for controlling length variation of a lead screw of a CNC apparatus due to thermal expansion. The method comprises pre-stressing, deflection detection and cooling so as to maintain the length of the lead screw substantially unchanged with respect to a bed, have an acceptable positioning accuracy, have a sufficient axial stiffness, and prevent the apparatus from being damaged in high speed rotation and/or when load is high.

The above and other objects, features and advantages of the invention will become apparent from the following detailed description taken with the accompanying drawings.

### BRIEF DESCRIPTION OF THE DRAWINGS

FIG. 1 is a longitudinal sectional view of a first conventional arrangement of a lead screw based feed mechanism;

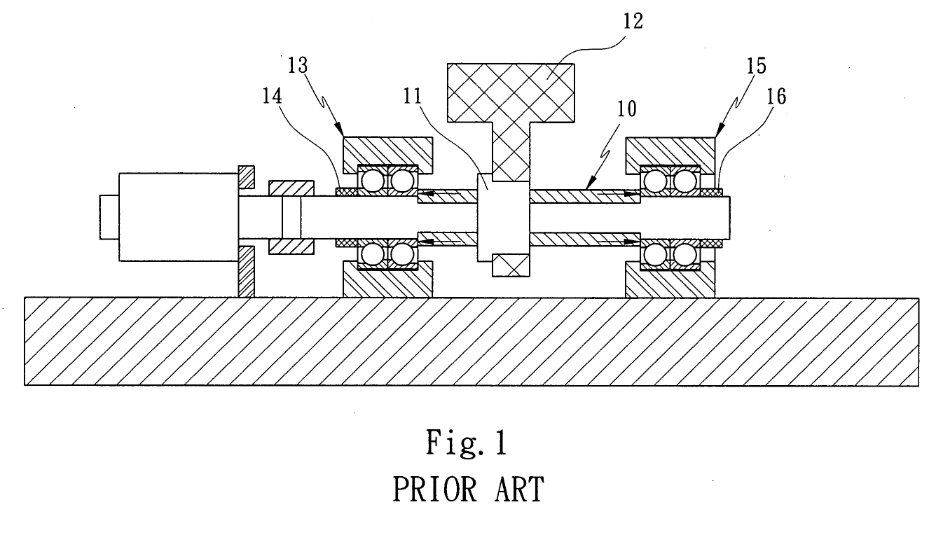

FIG. 2 a longitudinal sectional view of a second conventional arrangement of a lead screw based feed mechanism with hollow cavity in the lead screw for cooling and controlling length variation of a lead screw of a feed mechanism due to thermal expansion when the machine is rotating in high speed and/or when load is high;

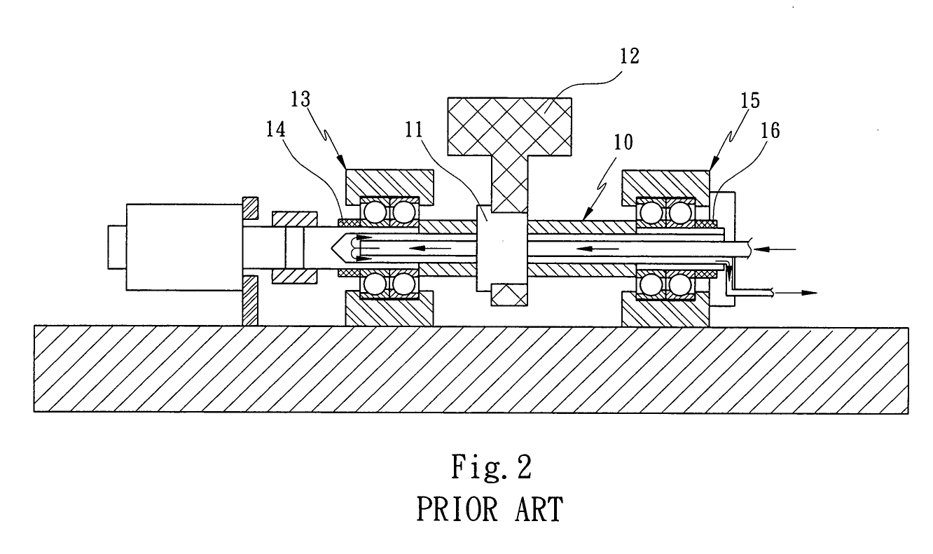

FIG. 3 is a longitudinal sectional view of a third conventional arrangement of a lead screw based feed mechanism;

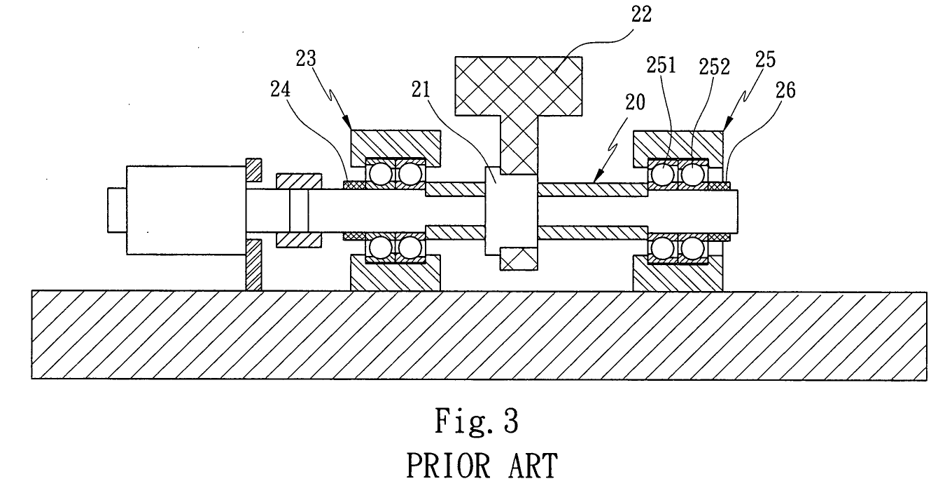

FIG. 4 is a longitudinal sectional view of a fourth conventional arrangement of a lead screw based feed mechanism with a displacement sensor for thermal distortion feedback;

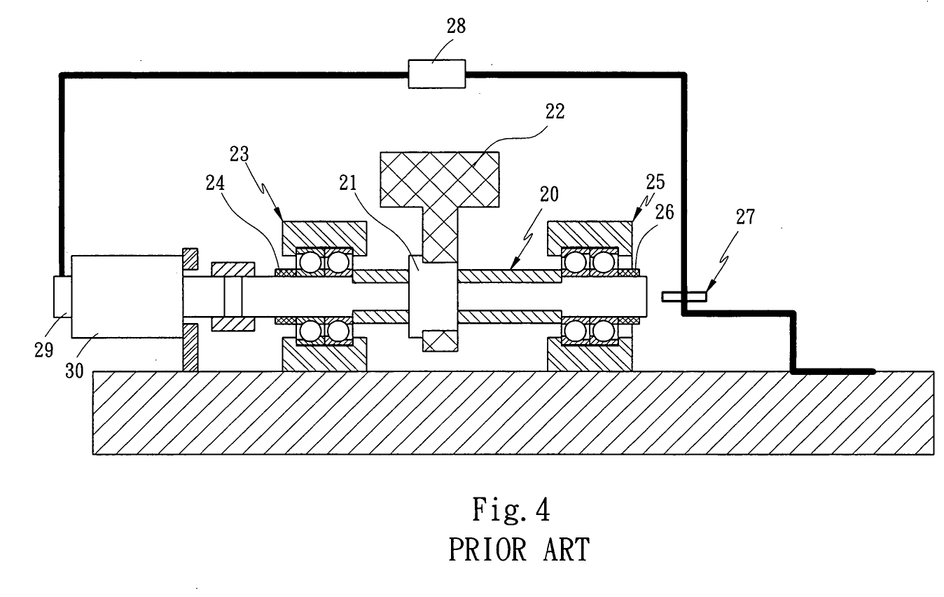

FIG. 5 is a longitudinal sectional view of a fifth conventional arrangement of a lead screw based feed mechanism with a linear scale for accurate positional feedback;

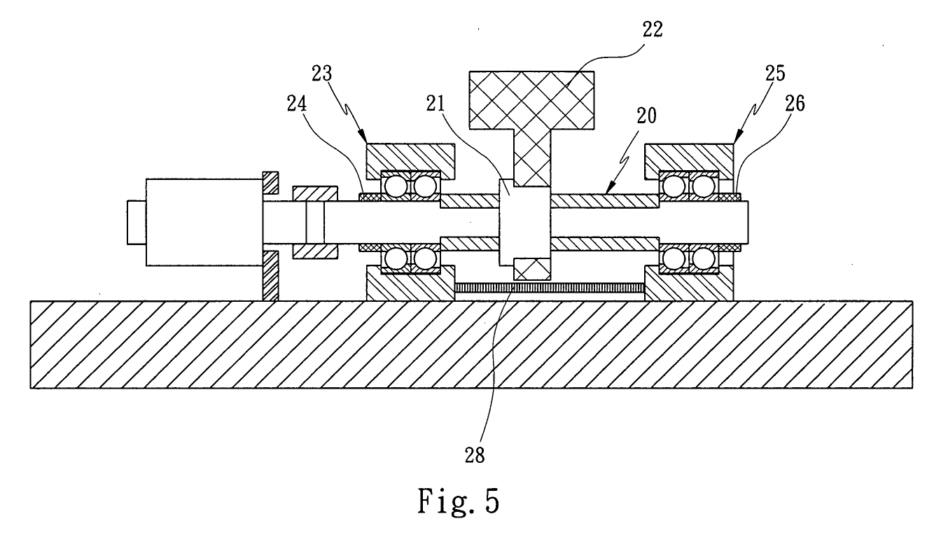

FIG. 6 is a longitudinal sectional view of a first preferred embodiment of CNC apparatus according to the invention for controlling length variation of its lead screw due to thermal expansion when the apparatus is rotating in high speed and/or when load is high;

FIG. 7 is a fragmentary view of the CNC apparatus of FIG. 6 where a pre-stressing is performed;

FIG. 8 is a view similar to FIG. 7 where length variation (e.g., elongation) of the lead screw due to thermal expansion is illustrated;

FIG. 9 is a view similar to FIG. 6 where cooling of the lead screw is illustrated;

FIG. 10 is a longitudinal sectional view of a second preferred embodiment of CNC apparatus according to the invention for controlling length variation of its lead screw due to thermal expansion when the apparatus is rotating in high speed and/or when load is high;

FIG. 11 is a fragmentary view of the CNC apparatus of FIG. 10 where length variation (e.g., elongation) of the lead screw due to thermal expansion is illustrated; and

FIG. 12 is a view similar to FIG. 11 where cooling of the lead screw is illustrated.

### DETAILED DESCRIPTION OF THE INVENTION

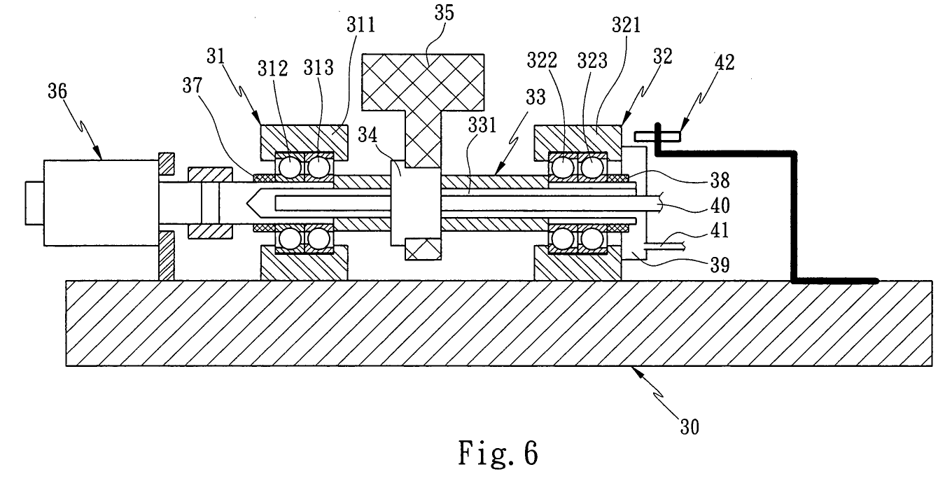

Referring to FIGS. 6 to 9, a CNC apparatus in accordance with a first preferred embodiment of the invention is shown. The CNC apparatus comprises a bed 30, a first ball bearing set 31 provided on the bed 30 and including an annular housing 311 provided on the bed 30, and two rows 312, 313 of balls positioned in the housing 311 by two inner races (not numbered) and two outer races (not numbered) disposed in opposing directions (i.e., the housing 311 is not adapted to deflect), a spaced second ball bearing set 32 provided on the bed 30 and including an annular housing 321 provided on the bed 30, and two rows 322, 323 of balls positioned in the housing 321 by two inner races 3231 and two outer races 3223, 3233 disposed in the same direction (i.e., the housing 321 is adapted to deflect), a lead screw 33 interconnected the ball bearing sets 31 and 32 and having an axial channel 331 for flowing cooling fluid, a first nut 37 for securing one end of the lead screw 33 to the first ball bearing set 31, a second nut 38 for securing the other end of the lead screw 33 to the second ball bearing set 32, a threaded carrier 34 threadedly put on the lead screw 33, a feed mechanism 35 fixedly secured to the threaded carrier 34, a drive unit (e.g., motor) 36 spaced from the first ball bearing set 31 and operatively connected to the first ball bearing set 31, an end cap 39 with rotary joint provided at the other end of the lead screw 33 with the second nut 38 concealed therein, a pipe 40 passing through the end cap 39 into the channel 331, a drain 41 at the other end of the lead screw 33 through the end cap 39 and being in fluid communication with the pipe 40, and a deflection detection unit 42 proximate the housing 321 (e.g., spaced from the housing 321 by a predetermined distance (e.g., 1 mm)) for measuring the deflection of the housing 321.

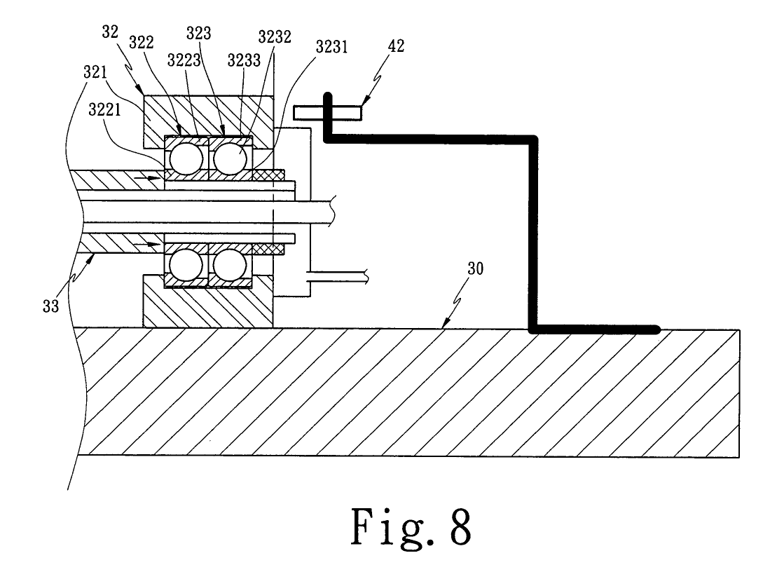

By configuring as above, the lead screw 33 is adapted to rotate and extend axially in either direction (e.g., toward right as shown in FIG. 8) but being restricted in radial movement in a rotational operation.

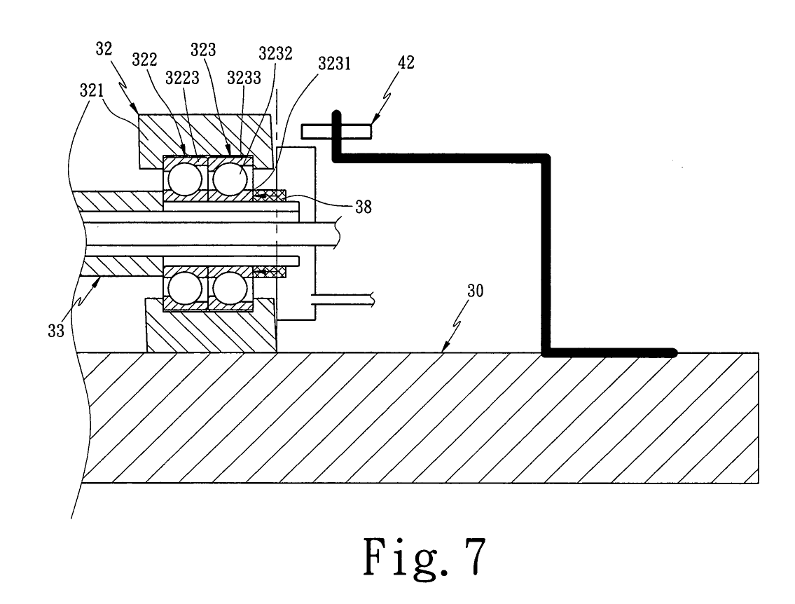

Referring to FIG. 7 specifically, a pre-stressing is illustrated. Clockwise turning (i.e., tightening) the second nut 38 will urge an inner race 3231 of the row 323 of balls against balls 3232 which in turn urge an outer race 3233 of the row 323 of balls against an outer race 3223 of the row 322 of balls. As a result, the inner race 3231, the balls 3232, and the outer races 3233 and 3223 shift a very small first distance leftward with the housing 321 being deflected counterclockwise about the bed 30.

Referring to FIG. 8 specifically, the lead screw 33 may elongate a minute amount due to temperature rise when the apparatus is rotating in high speed and/or when load is high. The increased length of the lead screw 33, as indicated by rightward arrows, can decrease the force exerted upon the second ball bearing set 32 by the second nut 38. As a result, the second ball bearing set 32 deflects clockwise to return to its original position before the pre-stressing. Also, length of the bed 30 increases. Further, the deflection detecting unit 42 is adapted to measure the predetermined distance between itself and the housing 321 (i.e., the deflection data) in order to determine whether there is a change. If so (i.e., there is change (e.g., lead screw elongation)), the defection data is then sent from the deflection detecting unit 42 to a control unit (not shown).

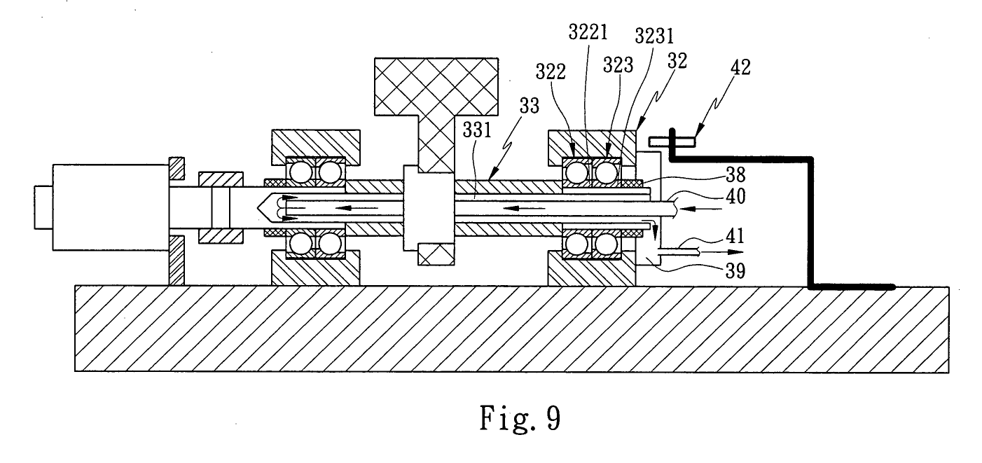

Referring to FIG. 9 specifically, length of the lead screw 33 increases due to thermal expansion if the apparatus continues to rotate in high speed and/or when load is high. It is contemplated by the invention in response to pre-stressing the lead screw 33, the subsequent rotational movement of the lead screw 33, and the clockwise deflection of the housing 321 the deflection detecting unit 42 immediately sends a signal to inform the control unit to open a valve of the pipe 40 for flowing cooling fluid (e.g., cooling water) through the channel 331 and eventually the cooling fluid is carried off by the drain 41. Moreover, the degree of opening the valve of the pipe 40 is precisely controlled by the control unit. The opening control of the valve of the pipe 40 (i.e., cooling the lead screw 33) aims at maintaining the predetermined distance between the deflection detecting unit 42 and the housing 321 in a minimized range when the apparatus is rotating in high speed and/or when load is high.

It is envisaged by the invention that the length of the lead screw 33 is substantially unchanged with respect to the bed 30 when the apparatus is rotating in high speed and/or when load is high. For example, length of the lead screw 33 increases from 5 m to about 5.05 m and length of a section of the bed 30 corresponding to the lead screw 33 also increases from 5 m to about 5.05 m when temperature of the bed rises from 20° C. to 21° C. This characteristic can prevent the apparatus from being damaged due to uneven temperature distribution. Moreover, the invention can have a desired positioning accuracy and a strong axial stiffness.

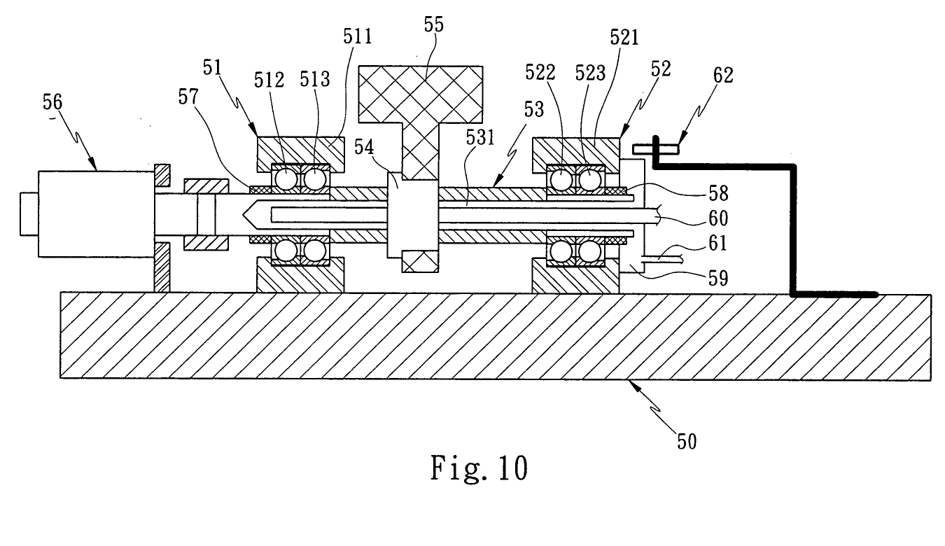

Referring to FIGS. 10 to 12, a CNC apparatus in accordance with a second preferred embodiment of the invention is shown. The characteristics of the second preferred embodiment are detailed below. The apparatus comprises a bed 50, a first ball bearing set 51 provided on the bed 50 and including an annular housing 511 provided on the bed 50, and two rows 512, 513 of balls positioned in the housing 511 by two inner races (not numbered) and two outer races (not numbered) disposed in opposing directions, (i.e., the housing 511 is not adapted to deflect), a spaced second ball bearing set 52 provided on the bed 50 and including an annular housing 521 provided on the bed 50, and two rows 522, 523 of balls positioned in the housing 521 by two inner races 5221 and two outer races 5223, 5233 disposed in opposing directions (i.e., the housing 521 is not adapted to deflect), a lead screw 53 interconnected the ball bearing sets 51 and 52 and having an axial channel 531 for flowing cooling fluid, a first nut 57 for securing one end of the lead screw 53 to the first ball bearing set 51, a second nut 58 for securing the other end of the lead screw 53 to the second ball bearing set 52, a threaded carrier 54 threadedly put on the lead screw 53, a feed mechanism 55 fixedly secured to the threaded carrier 54, a drive unit (e.g., motor) 56 spaced from the first ball bearing set 51 and operatively connected to the first ball bearing set 51, an end cap 59 with rotary joint provided at the other end of the lead screw 53 with the second nut 58 concealed therein, a pipe 60 passing through the end cap 59 into the channel 531, a drain 61 at the other end of the lead screw 53 through the end cap 59 and being in fluid communication with the pipe 60, and a deflection detecting unit 62 proximate the housing 521 (e.g., spaced from the housing 521 by a predetermined distance (e.g., 1 mm)) for measuring the deflection of the housing 521.

By configuring as above, the lead screw 53 is adapted to rotate but being restricted in both axial and radial movements in a rotational operation.

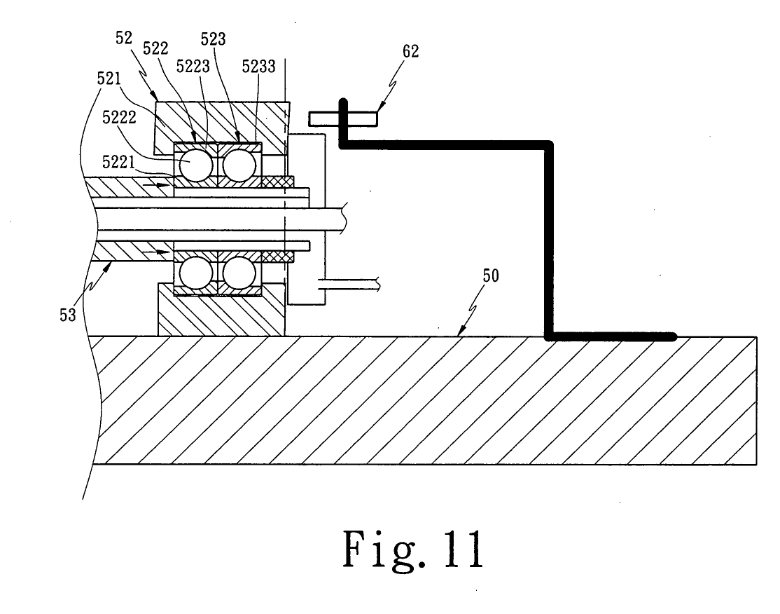

Referring to FIG. 11 specifically, the lead screw 53 may elongate a minute amount due to temperature rise when the apparatus is rotating in high speed and/or when load is high. The increased length of the lead screw 53, as indicated by rightward arrows, can increase the force exerted upon the pre-stressed second ball bearing set 52. As a result, the second ball bearing set 52 deflects clockwise to decrease the predetermined distance between itself and the deflection detecting unit 62. Further, the deflection detecting unit 62 is adapted to measure the predetermined distance between itself and the housing 521 (i.e., the deflection data) in order to determine whether there is a change. If so (i.e., there is change (e.g., lead screw elongation)), the defection data is then sent from the deflection detecting unit 62 to a control unit (not shown).

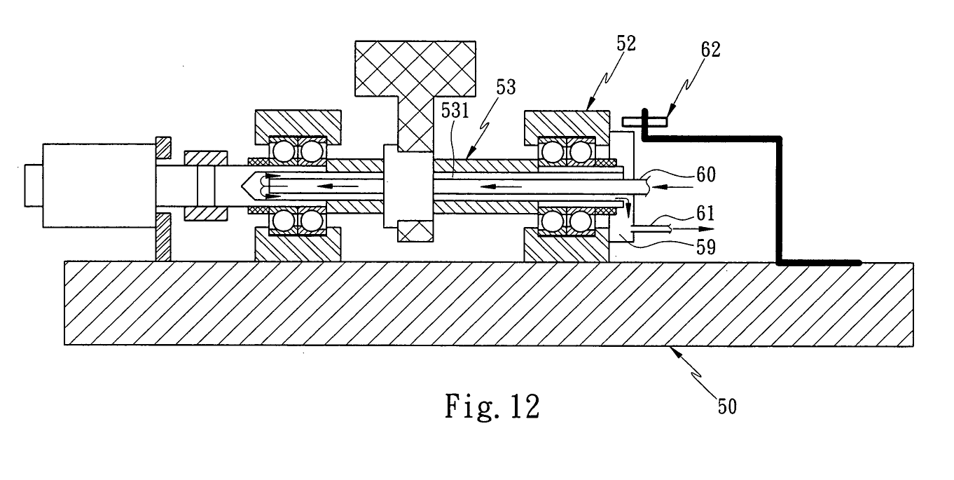

Referring to FIG. 12 specifically, length of the lead screw 53 continuously increases due to thermal expansion if the apparatus continues to rotate in high speed and/or when load is high. It is understood that the lead screw 53 will deform and thus damages the first ball bearing set 51 and/or the second ball bearing set 52 since both the first and second ball bearing sets 51, 52 are not adapted to deflect. Advantageously, it is contemplated by the invention that after detecting any deflection of the second ball bearing set 52 the deflection detecting unit 62 sends a signal to inform the control unit to open a valve of the pipe 60 for flowing cooling fluid (e.g., cooling water) through the channel 531 and eventually the cooling fluid is carried off by the drain 61. Moreover, the degree of opening the valve of the pipe 60 is precisely controlled by the control unit. The opening control of the valve of the pipe 60 (i.e., cooling the lead screw 53) aims at maintaining the predetermined distance between the deflection detecting unit 62 and the housing 521 in a minimized range when the apparatus is rotating in high speed and/or when load is high.

It is envisaged by the invention that the length of the lead screw 53 is substantially unchanged with respect to the bed 50 when the apparatus is rotating in high speed and/or when load is high. For example, length of the lead screw 53 increases from 5 m to about 5.05 m and length of a section of the bed 50 corresponding to the lead screw 53 also increases from 5 m to about 5.05 m when temperature of the bed rises from 20° C. to 21° C. The second embodiment also has other beneficial advantages the same as the first embodiment.

While the invention herein disclosed has been described by means of specific embodiments, numerous modifications and variations could be made thereto by those skilled in the art without departing from the scope and spirit of the invention set forth in the claims.

What is claimed is:

1. A computer numerical control (CNC) apparatus, comprising:
a lead screw having an axial channel;
a threaded carrier threadedly put on the lead screw and securely fixed on a feed mechanism;
a fixed bed;
a first ball bearing set disposed on the bed with one end of the lead screw rotatably fastened therein wherein the first ball bearing set is not adapted to deflect relative to the bed;
a second ball bearing set disposed on the bed with the other end of the lead screw rotatably fastened therein wherein the second ball bearing set is adapted to deflect relative to the bed;
adjusting means operatively connected to the other end of the lead screw;
a pipe looping through the adjusting means and the channel;
a deflection detecting unit proximate the second ball bearing set; and
a control unit electrically connected to the deflection detecting unit,
wherein in response to tightening the second ball bearing set by turning the adjusting means the second ball bearing set deflects a first deflection toward a first direction relative to the bed; and
wherein in response to rotating the lead screw:
the lead screw increases its length by extending its other end and the second ball bearing set is loosened to deflect a second deflection toward a second direction opposing the first direction relative to the bed; and
in response to detecting the second deflection by the deflection detecting unit the deflection detecting unit sends a signal to enable the control unit to adjustably open the pipe to flow cooling fluid through the channel, thereby maintaining the length of the lead screw substantially unchanged with respect to the bed.

2. The CNC apparatus of claim 1, wherein each of the first and the second ball bearing sets includes at least one row of balls.

3. The CNC apparatus of claim 2, wherein the number of the at least one row of balls of the first ball bearing set is equal to that of the second ball bearing set.

4. The CNC apparatus of claim 2, wherein the number of the at least one row of balls of the first ball bearing set is not equal to that of the second ball bearing set.

5. A computer numerical control (CNC) apparatus, comprising:
a lead screw having an axial channel;
a threaded carrier threadedly put on the lead screw and securely fixed on a feed mechanism;
a fixed bed;
a first ball bearing set disposed on the bed with one end of the lead screw rotatably fastened therein wherein the first ball bearing set is not adapted to deflect relative to the bed;
a second ball bearing set disposed on the bed with the other end of the lead screw rotatably fastened therein wherein the second ball bearing set is not adapted to not deflect relative to the bed;
adjusting means operatively connected to the other end of the lead screw;
a pipe looping through the adjusting means and the channel;
a deflection detecting unit proximate the second ball bearing set; and
a control unit electrically connected to the deflection detecting unit,
wherein in response to rotating the lead screw and detecting a deflection of the second ball bearing set by the deflection detecting unit the deflection detecting unit sends a signal to enable the control unit to adjustably open the pipe to flow cooling fluid through the channel, thereby maintaining the length of the lead screw substantially unchanged with respect to the bed.

6. The CNC apparatus of claim 5, wherein each of the first and the second ball bearing sets includes at least one row of balls.

7. The CNC apparatus of claim 6, wherein the number of the at least one row of balls of the first ball bearing set is equal to that of the second ball bearing set.

8. The CNC apparatus of claim 6, wherein the number of the at least one row of balls of the first ball bearing set is not equal to that of the second ball bearing set.

9. In a computer numerical control (CNC) apparatus including a lead screw having an axial channel, a threaded carrier threadedly put on the lead screw and securely fixed on a feed mechanism, a fixed bed, a first ball bearing set disposed on the bed with one end of the lead screw rotatably fastened therein wherein the first ball bearing set is not adapted to deflect relative to the bed, a second ball bearing set disposed on the bed with the other end of the lead screw rotatably fastened therein, adjusting means operatively connected to the other end of the lead screw, a pipe looping through the adjusting means and the channel, a deflection detecting unit proximate the second ball bearing set, and a control unit electrically connected to the deflection detecting unit, a method for controlling length of the lead screw comprising the steps of:
(a) rotating the lead screw to increase its length, loosen the second ball bearing set, and deflect the second ball bearing set relative to the bed; and
(b) in response to detecting the deflection by the deflection detecting unit causing the deflection detecting unit to send a signal to enable the control unit to adjustably open the pipe to flow cooling fluid through the channel, thereby maintaining the length of the lead screw substantially unchanged with respect to the bed.

10. The method of claim 9, wherein each of the first and the second ball bearing sets includes at least one row of balls.

11. The method of claim 10, wherein the number of the at least one row of balls of the first ball bearing set is equal to that of the second ball bearing set.

12. The method of claim 10, wherein the number of the at least one row of balls of the first ball bearing set is not equal to that of the second ball bearing set.
